(19) United States
(12) Patent Application Publication
(10) Pub. No.: US 2025/0372968 A1
(43) Pub. Date: Dec. 4, 2025

(54) PROTECTOR

(71) Applicants: Yazaki Corporation, Tokyo (JP); SUBARU CORPORATION, Tokyo (JP)

(72) Inventors: Shintaro NAMIKI, Shizuoka (JP); Kohei Watanabe, Shizuoka (JP); Hiromasa Ogawa, Tokyo (JP); Aya Someya, Tokyo (JP)

(73) Assignees: Yazaki Corporation, Tokyo (JP); SUBARU CORPORATION, Tokyo (JP)

(21) Appl. No.: 19/196,899

(22) Filed: May 2, 2025

(30) Foreign Application Priority Data
Jun. 3, 2024 (JP) 2024-089763

(51) Int. Cl. H02G 3/04

(52) U.S. Cl. CPC H02G 3/0418

(57) ABSTRACT

A protector includes a bottom wall portion, a pair of side wall portions, an accommodation space portion, and a partition wall. The bottom wall portion extends along a height direction in a state of being fixed to a part to be fixed. The pair of side wall portions are provided on both sides with the bottom wall portion interposed therebetween with respect to the height direction and formed to protrude along a depth direction. The accommodation space portion is defined and formed by the bottom wall portion and the pair of side wall portions, into which a plurality of wiring members is inserted. The partition wall is formed to protrude from the bottom wall portion along the depth direction and partitions the accommodation space portion into a first accommodation space portion and a second accommodation space portion, and has a root portion formed in a curved shape.

### CROSS-REFERENCE TO RELATED APPLICATION(S)

The present application claims priority to and incorporates by reference the entire contents of Japanese Patent Application No. 2024-089763 filed in Japan on Jun. 3, 2024.

### BACKGROUND OF THE INVENTION

### 1. Field of the Invention

The present invention relates to a protector.

### 2. Description of the Related Art

For example, Japanese Patent Application Laid-open No. JP 2014-82880 A discloses a protector in which a plurality of wiring members is inserted into a protector main body.

Meanwhile, although the protector described in Japanese Patent Application Laid-open No. JP 2014-82880 A described above can hold the wiring member with the protector main body (base member), it is difficult to keep a positional relationship between the wiring members, and there is room for further improvement in holding the wiring member at an appropriate position.

### SUMMARY OF THE INVENTION

In light of the foregoing, an object of the present invention is to provide a protector capable of holding and accommodating a wiring member at an appropriate position.

In order to achieve the above mentioned object, a protector according to one aspect of the present invention includes a bottom wall portion extending along a vertical direction in a state of being fixed to a part to be fixed; a pair of side wall portions provided on both sides with the bottom wall portion interposed therebetween with respect to the vertical direction and formed so as to protrude along a protruding direction intersecting the vertical direction; an accommodation space portion defined and formed by the bottom wall portion and the pair of side wall portions, into which a plurality of wiring members having conductivity is inserted; and a partition wall that is formed so as to protrude from the bottom wall portion along the protruding direction and partitions the accommodation space portion into a first accommodation space portion positioned on an upper side in the vertical direction, through which a part of the plurality of wiring members is inserted, and a second accommodation space portion positioned on a lower side in the vertical direction, through which at least a remaining part of the plurality of wiring members is inserted, wherein the partition wall has a root portion protruding from the bottom wall portion and formed in a curved shape.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a protector according to an embodiment;

FIG. 2 is a side view illustrating a schematic configuration of a protector according to the present embodiment; and

FIG. 3 is a cross-sectional view taken along line A-A illustrated in FIG. 2.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiments include those that can be easily replaced by those skilled in the art or those that are substantially the same.

### Embodiment

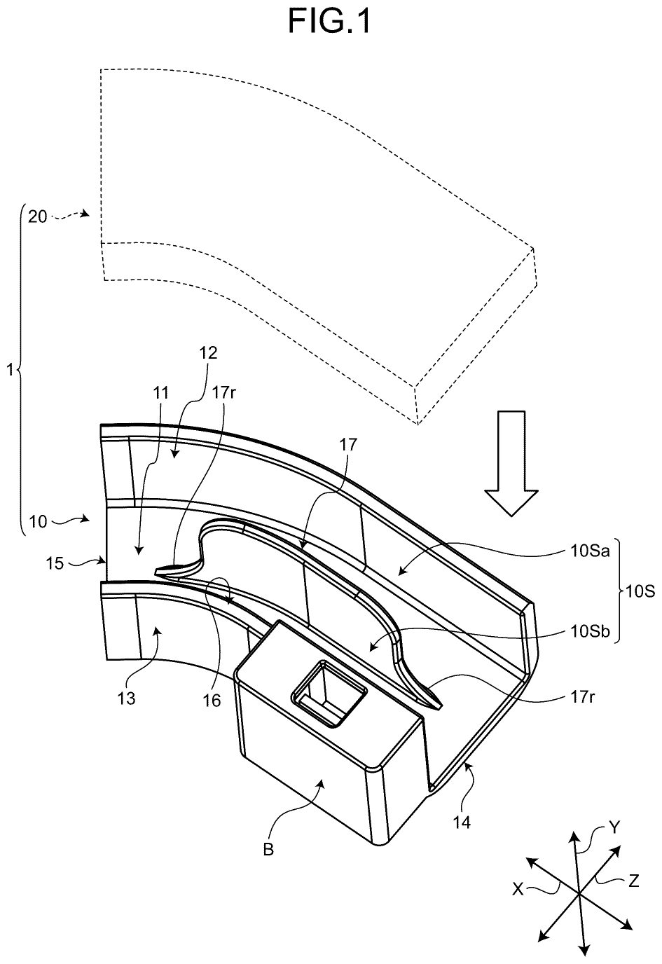

A protector 1 illustrated in FIG. 1 is incorporated in a wire harness mounted on a vehicle such as an automobile. In addition, for example, the wire harness is configured for connection between devices mounted on a vehicle such that a plurality of wiring members used for power supply and signal communication is bundled to form a collective component, and the plurality of wiring members is connected to each device by a connector or the like.

Then, the protector 1 of the present embodiment is provided with a partition wall 17 capable of vertically dividing an accommodation space portion 10S through which the plurality of wiring members W is inserted, and a root portion 17r (rising portion) of the partition wall 17 is formed in a curved shape, thereby realizing a configuration capable of holding and accommodating the wiring members W at an appropriate position. Hereinafter, the configuration of the protector 1 will be described in detail with reference to FIGS. 1 to 3.

In the following description, among a first direction, a second direction, and a third direction intersecting each other, the first direction is referred to as “length direction X”, the second direction is referred to as “depth direction Y”, and the third direction is referred to as “height direction Z”. Here, the length direction X, the depth direction Y, and the height direction Z are orthogonal to each other. In addition, the length direction X typically corresponds to the length direction (longitudinal direction) of the protector 1, the left-right direction of a part to be fixed A, and the like. In addition, the depth direction Y typically corresponds to the thickness direction of the protector 1, the thickness direction of the part to be fixed A. In addition, the height direction Z typically corresponds to the width direction (transverse direction) of the protector 1, the up-down direction of the part to be fixed A, and the like. Therefore, in the present embodiment, the height direction Z corresponds to the vertical direction, and the depth direction Y corresponds to the protruding direction intersecting the vertical direction, that is, the horizontal direction. Note that each direction used in the following description will be described as a direction in a state where the protector 1 is fixed to the part to be fixed A unless otherwise specified.

Further, the part to be fixed A referred to herein is, for example, a body of a vehicle.

Furthermore, the wire harness may further include an electrical connection box, a grommet, a fixture, a connector, and the like.

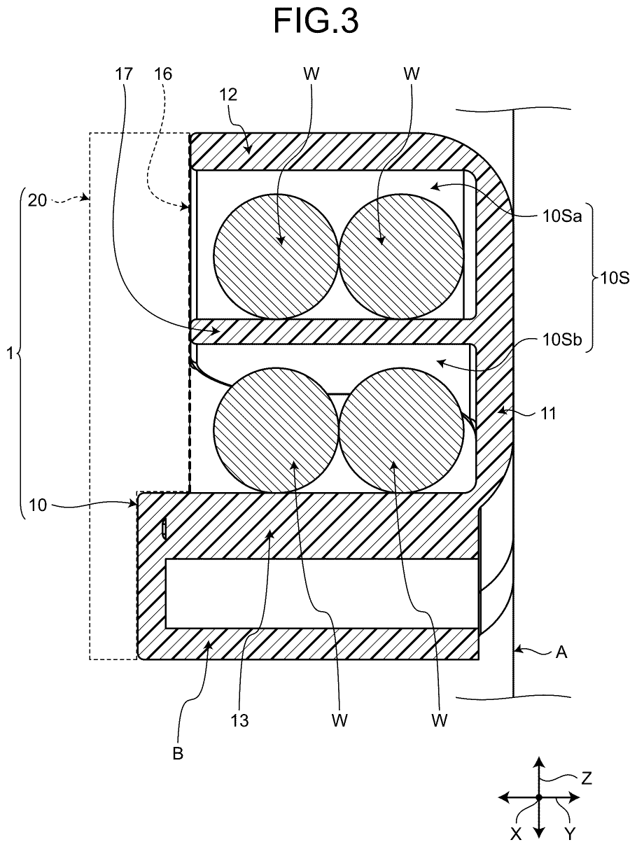

As illustrated in FIGS. 1 and 3, the protector 1 includes a base member 10 accommodating a plurality of wiring members W inside, and a cover member 20.

### Wiring Member

The wiring member W is routed in the vehicle and electrically connects each device. The wiring member W of the present embodiment is an insulated wire configured to include a conductive portion (core wire) having conductivity and an insulating coating portion having insulation, and the conductive portion is coated with the insulating coating portion. The conductive portion here is a stranded wire obtained by twisting a plurality of conductive element wires. In addition, the insulating coating portion is extrusion molded to be formed of, for example, a resin material having an insulating property (PP, PVC, crosslinked PE, or the like, which is appropriately selected in consideration of abrasion resistance, chemical resistance, heat resistance, and the like). Note that the conductive portion may be a bundle of a plurality of element wires.

In addition, the wiring member W has a cross-sectional shape of the conductive portion (a cross-sectional shape in a direction intersecting an extending direction of the wiring member W) which is a substantially circular shape, and a cross-sectional shape of the insulating coating portion which is a substantially annular shape, and has a substantially circular cross-sectional shape as a whole (see FIG. 3). In addition, in the present embodiment, four wiring members W are provided, and each of the wiring members W is accommodated inside the protector 1.

### Base Member

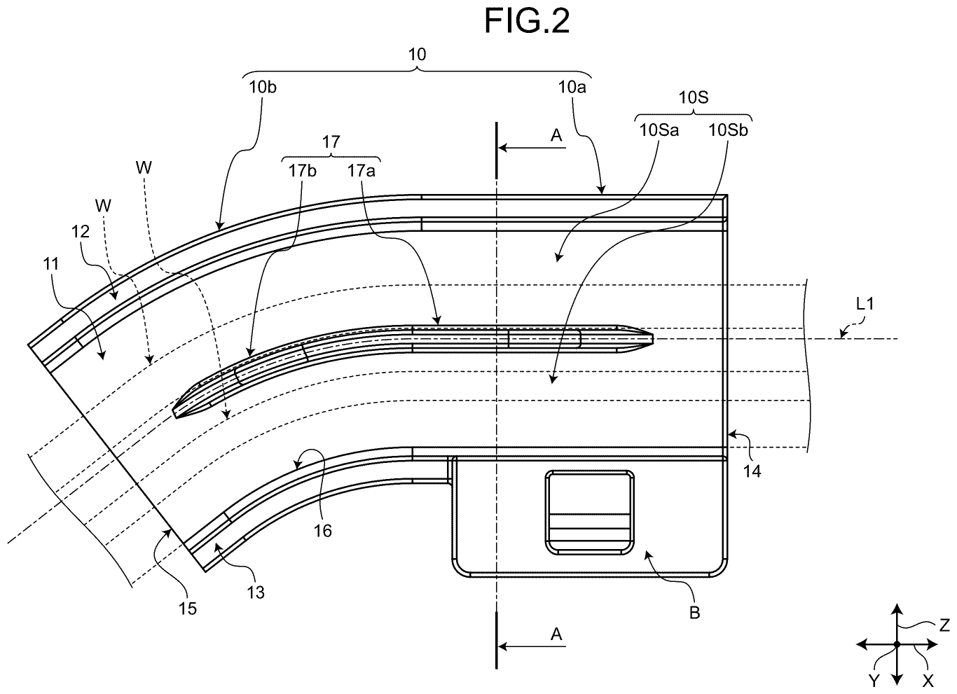

The base member 10 is formed of an insulating resin material or the like, and accommodates the wiring members W therein to protect the wiring members W. As illustrated in FIGS. 1 to 3, the base member 10 includes a bottom wall portion 11 and a pair of side wall portions 12 and 13. In the base member 10, the bottom wall portion 11 and the pair of side wall portions 12 and 13 are integrated, and a cross-sectional shape along the height direction Z is formed in a U shape. Further, as illustrated in FIG. 3, in the base member 10, when viewed from the length direction X, the bottom wall portion 11 extends along the height direction Z, and the pair of side wall portions 12 and 13 extends along the depth direction Y intersecting the height direction Z. Therefore, the base member 10 of the present embodiment includes an accommodation space portion 10S as an internal space, a pair of insertion openings 14 and 15 (see FIGS. 1 and 2) opening along the extending direction L1 of the protector 1, and an opening 16 (see FIGS. 1 to 3) opening in the depth direction Y.

In addition, as illustrated in FIG. 2, the base member 10 includes a first part 10a and a second part 10b bent with respect to the first part 10a. The first part 10a is linearly formed along the length direction X. In addition, the second part 10b is formed in a curved shape and is formed in a rounded shape. Therefore, the base member 10 of the present embodiment is formed in a J shape when viewed from the depth direction Y. Furthermore, as illustrated in FIG. 2, the extending direction L1 of the protector 1 is curved in a J shape and extends according to the shape of the base member 10.

### Cover Member

The cover member 20 is formed of an insulating resin material or the like, and protects the wiring members W accommodated inside the base member 10 by being assembled to the base member 10 as illustrated in FIGS. 1 and 3. As illustrated in FIG. 3, the cover member 20 is formed in a size capable of closing the opening 16 of the base member 10. In addition, the cover member 20 is formed in a plate shape extending along the length direction X and the height direction Z in a state where the opening 16 of the base member 10 is closed, and the depth direction Y is the plate thickness direction. At this time, the cover member 20 is assembled to the base member 10 via a locking mechanism (not illustrated) to be held at a closing position where the opening 16 is closed. In addition, the cover member 20 is disposed at a distance from the bottom wall portion along the depth direction Y which is the opening direction of the opening 16 in a state where the opening 16 is closed, and is positioned to face the bottom wall portion 11. The locking mechanism here includes, for example, locking portions provided on the side wall portions 12 and 13 of the base member 10 and locked portions provided on the cover member 20 so as to correspond to the locking portions.

Next, the base member 10 configured as described above will be described in detail.

The bottom wall portion 11 is a portion extending along the length direction X and the height direction Z and formed in a plate shape in which the depth direction Y is the plate thickness direction. As illustrated in FIGS. 1 and 3, the bottom wall portion 11 is disposed at a distance from the opening 16 along the depth direction Y which is the opening direction of the opening 16 and is positioned to face the opening 16. Further, the bottom wall portion 11 is fixed to the part to be fixed A extending along the length direction X and the height direction Z so as to be disposed facing the part to be fixed A. Therefore, the bottom wall portion 11 of the present embodiment extends along the plane direction of the part to be fixed A in a state of being fixed to the part to be fixed A. As illustrated in FIG. 2, the bottom wall portion 11 of the present embodiment is formed according to the shapes of the first part 10a and the second part 10b of the base member 10. Therefore, the bottom wall portion 11 is formed to be bent in the extending direction L1 of the protector 1.

The side wall portions 12 and 13 extend along the extending direction L1 and the depth direction Y of the protector 1, and are formed in a plate shape in which a direction intersecting the extending direction L1 of the protector 1 when viewed from the depth direction Y is a plate thickness direction. As illustrated in FIGS. 2 and 3, the side wall portions 12 and 13 are disposed at a distance along the height direction Z intersecting the opening direction of the opening 16. In addition, the side wall portions 12 and 13 are positioned to face each other by disposing the side wall portion 12 on the upper side in the height direction Z and disposing the side wall portion 13 on the lower side in the height direction Z. As illustrated in FIG. 3, the side wall portions 12 and 13 are connected to both ends of the bottom wall portion 11 in the height direction Z, respectively. More specifically, the side wall portion 12 is erected from an upper end of the bottom wall portion 11 in the height direction Z, and the side wall portion 13 is erected from a lower end of the bottom wall portion 11 in the height direction Z. Therefore, the side wall portions 12 and 13 of the present embodiment are provided on both sides with the bottom wall portion 11 interposed therebetween with respect to the height direction Z in a state of being fixed to the part to be fixed A, and are formed to protrude in the depth direction Y intersecting the height direction Z. In addition, as illustrated in FIG. 2, the side wall portions 12 and 13 of the present embodiment are formed according to the shapes of the first part 10a and the second part 10b of the base member 10. Therefore, the side wall portions 12 and 13 are formed to be bent in the extending direction L1 of the protector 1. In addition, a fixing mechanism B for the part to be fixed A is provided outside the side wall portion 13 of the present embodiment. Therefore, the base member 10 is typically fixed to the part to be fixed A via a fixing member such as a bracket mounted on the part to be fixed A by inserting and assembling the fixing member into the fixing mechanism B.

The accommodation space portion 10S is a portion defined and formed by the bottom wall portion 11 and the pair of side wall portions 12 and 13. In addition, the insertion openings 14 and 15 are portions defined and formed by the ends (also referred to as edge portions) of the pair of side wall portions 12 and 13, and are portions sandwiched between the ends of the side wall portions 12 and 13 positioned along the extending direction L1 of the protector 1. As illustrated in FIG. 2, the insertion openings 14 and 15 are disposed at a distance along the extending direction L1 of the protector 1 by forming the insertion openings 14 on the first part 10a side of the base member 10 and the second part 10b side of the base member 10. Therefore, in the base member 10 of the present embodiment, by inserting the wiring member W into the accommodation space portion 10S through the pair of insertion openings 14 and 15, the wiring member W can be routed in a state of being curved in a J shape along the extending direction L2 of the protector 1.

The opening 16 is a portion defined and formed by edge portions of the pair of side wall portions 12 and 13, and is a portion sandwiched by distal ends of the side wall portions 12 and 13 positioned along the depth direction Y. Here, the distal ends of the side wall portions 12 and 13 are portions opposite to the root portion protruding from the bottom wall portion 11. In the protector 1 of the present embodiment, when the cover member 20 is assembled to the base member 10, the opening 16 is closed by the cover member 20, and the accommodation space portion 10S located corresponding to the opening 16 is covered (see FIG. 3). Therefore, the protector 1 can hold the wiring members W by accommodating the wiring members W in the internal space surrounded by the wall portion of the base member 10 and the wall portion of the cover member 20. In addition, in the protector 1, the base member 10 is fixed to the part to be fixed A via a fixing member (not illustrated) such as a bracket, so that the wiring path of the wiring member W accommodated inside the protector 1 can be restricted.

### Partition Wall

Next, a configuration of the partition wall 17 provided in the base member 10 will be described.

The partition wall 17 is formed of an insulating resin material or the like, and is provided inside the base member 10 to divide the accommodation space portion 10S of the base member 10 into a plurality of spaces. The partition wall 17 extends, as illustrated in FIG. 2, along the extending direction L1 and the depth direction Y of the protector 1, and is formed in a plate shape in which a direction intersecting the extending direction L1 of the protector 1 when viewed from the depth direction Y is a plate thickness direction. As illustrated in FIGS. 2 and 3, the partition wall 17 is erected from the vicinity of the center in the height direction Z of the bottom wall portion 11, and is provided between the side wall portion 12 positioned on the upper side in the height direction Z and the side wall portion 13 positioned on the lower side in the height direction Z. Therefore, in the partition wall 17 of the present embodiment, the pair of side wall portions 12 and 13 is provided on both sides in the height direction Z in a state of being fixed to the part to be fixed A, and is sandwiched between the side wall portion 12 positioned on the upper side in the height direction Z and the side wall portion 13 positioned on the lower side in the height direction Z. The partition wall 17 is formed so as to protrude in the depth direction Y intersecting the height direction Z, and is provided along the pair of side wall portions 12 and 13. In addition, the partition wall 17 is formed integrally with the bottom wall portion 11 and the pair of side wall portions 12 and 13 described above, so that the accommodation space portion 10S of the base member 10 can be partitioned into two of a first accommodation space portion 10Sa positioned on the upper side in the height direction Z and a second accommodation space portion 10Sb positioned on the lower side in the height direction Z.

In addition, as illustrated in FIG. 2, the partition wall 17 includes a first part 17a and a second part 17b bent with respect to the first part 17a. The first part 17a is linearly formed along the length direction X. In addition, the second part 17b is formed in a curved shape and is formed in a rounded shape. Therefore, the partition wall 17 of the present embodiment is formed in a J shape when viewed from the depth direction Y. Further, the partition wall 17 is formed to be partially bent, so that rigidity can be enhanced as compared with a case where the partition wall is formed linearly.

As illustrated in FIG. 1, the partition wall 17 has a root portion 17r protruding from the bottom wall portion 11 formed in a curved shape. Therefore, in the partition wall 17 of the present embodiment, the corner portion formed between the partition wall and the bottom wall portion 11 is formed in a rounded shape, and the shape viewed from the plate thickness direction is formed in a curved shape concave toward the inner side (inside corner). Therefore, in the partition wall 17, since the root portion 17r is formed by a concave curved surface, it is possible to prevent stress concentration as compared with a case where the root portion 17r is formed linearly.

In addition, in the partition wall 17 configured as described above, the weight of the wiring member W inserted into the first accommodation space portion 10Sa is applied, and in the pair of side wall portions 12 and 13, the weight of the wiring member W inserted into the second accommodation space portion 10Sb is applied to the side wall portion 13 positioned on the lower side in the height direction Z. In the base member 10 of the present embodiment, as illustrated in FIG. 3, four wiring members W are inserted into the accommodation space portion 10S, two of the four wiring members W are inserted into the first accommodation space portion 10Sa, and the remaining two wiring members W are inserted into the second accommodation space portion 10Sb. Further, the two wiring members W inserted into the first accommodation space portion 10Sa and the two wiring members W inserted into the second accommodation space portion 10Sb are arranged side by side along the depth direction Y. Therefore, the partition wall 17 comes into contact with each of the two wiring members W inserted through the first accommodation space portion 10Sa, so that the wiring members W can be placed and each of the wiring members W can be placed without being stacked. In addition, the side wall portion 13 positioned on the lower side in the height direction Z comes into contact with each of the two wiring members W inserted through the second accommodation space portion 10Sb, so that the wiring members W can be placed and each of the wiring members W can be placed without being stacked. Therefore, in the base member 10 of the present embodiment, by dividing the accommodation space portion 10S through which the wiring members W are inserted into two of the first accommodation space portion 10Sa and the second accommodation space portion 10Sb by the partition wall 17, the number of the wiring members W accommodated in each of the first accommodation space portion 10Sa and the second accommodation space portion 10Sb can be reduced. In addition, the base member 10 can reduce the weight applied to the bottom portion of the first accommodation space portion 10Sa and the bottom portion of the second accommodation space portion 10Sb by reducing the number of the wiring members W accommodated in the first accommodation space portion 10Sa and the second accommodation space portion 10Sb, respectively.

The protector 1 described above includes the bottom wall portion 11 extending along the height direction Z (corresponding to the vertical direction) in a state of being fixed to the part to be fixed A, the pair of side wall portions 12 and 13 provided on both sides with the bottom wall portion 11 interposed therebetween with respect to the height direction Z and formed so as to protrude along the protruding direction (corresponding to the depth direction Y) intersecting the height direction z, the accommodation space portion 10S defined and formed by the bottom wall portion 11 and the pair of side wall portions 12 and 13, into which the plurality of wiring members W having conductivity is inserted, and the partition wall 17 that is formed so as to protrude from the bottom wall portion 11 along the depth direction Y and partitions the accommodation space portion 10S into the first accommodation space portion 10Sa positioned on the upper side in the height direction Z, through which a part of the plurality of wiring members W is inserted, and the second accommodation space portion 10Sb positioned on the lower side in the height direction Z, through which at least a remaining part of the plurality of wiring members W is inserted, and the partition wall 17 has the root portion 17r protruding from the bottom wall portion 11 and formed in a curved shape.

According to such a configuration, in the protector 1, the accommodation space portion 10S defined and formed by the bottom wall portion 11 and the pair of side wall portions 12 and 13 is vertically divided by the partition wall 17, so that the plurality of wiring members W inserted into one accommodation space portion 10S can be divided into the wiring members W inserted into the first accommodation space portion 10Sa and the wiring members W inserted into the second accommodation space portion 10Sb. In addition, the protector 1 reduces the number of the wiring members W accommodated in each of the first accommodation space portion 10Sa and the second accommodation space portion 10Sb, so that it is possible to disperse the load applied per unit area of the partition wall 17 serving as the bottom portion of the first accommodation space portion 10Sa and the side wall portion (the side wall portion 13 in the present embodiment) serving as the bottom portion of the second accommodation space portion 10Sb when the wire harness vibrates due to the vibration of the vehicle or the like. In addition, the protector 1 can hold the wiring member W at a more appropriate position by reducing the number of the wiring members W accommodated in each of the first accommodation space portion 10Sa and the second accommodation space portion 10Sb, so that it is possible to suppress twisting of the wiring member W when the wire harness vibrates due to vibration of the vehicle or the like. In addition, when the wire harness vibrates in the height direction Z due to the vibration of the vehicle or the like, the protector 1 can suppress application of a large load to the entire protector 1 by applying a large load to the partition wall 17 serving as the bottom portion of the first accommodation space portion 10Sa and the side wall portion 13 serving as the bottom portion of the second accommodation space portion 10Sb. In addition, since the root portion 17r of the partition wall 17 is formed in a curved shape, it is possible to prevent stress concentration as compared with a case where the root portion 17r is formed linearly. Therefore, the protector 1 can ensure sufficient strength that can withstand a large load applied to the partition wall 17. Therefore, in the protector 1 of the present embodiment, the accommodation space portion 10S through which the plurality of wiring members W is inserted is vertically divided by the partition wall 17, so that the wiring members W can be held and accommodated at appropriate positions.

Further, the partition wall 17 of the protector 1 described above is inserted into the first accommodation space portion 10Sa and comes into contact with the plurality of wiring members W arranged side by side along the depth direction Y to place the wiring members W, and the side wall portion 13 positioned on the lower side in the height direction Z of the pair of side wall portions 12 and 13 is inserted into the second accommodation space portion 10Sb and comes into contact with the plurality of wiring members W arranged side by side along the depth direction Y to place the wiring members W. According to such a configuration, the protector 1 is disposed in a state where the plurality of wiring members W inserted into the first accommodation space portion 10Sa is in contact with the partition wall 17 and is arranged side by side in a line. In addition, the protector 1 is disposed in a state where the plurality of wiring members W inserted into the second accommodation space portion 10Sb is in contact with the side wall portion 13 and is arranged side by side in a line. Therefore, the protector 1 can correct the positions of the plurality of wiring members W inserted into the first accommodation space portion 10Sa and the second accommodation space portion 10Sb, thereby appropriately keeping the positional relationship between the wiring members W. In addition, by correcting the positions of the wiring members W inserted into the protector 1, it is possible to suppress twisting of the wiring members W or application of a large load to the partition wall 17 serving as the bottom portion of the first accommodation space portion 10Sa and the side wall portion 13 serving as the bottom portion of the second accommodation space portion 10Sb when the wire harness vibrates due to vibration of the vehicle or the like. Therefore, the protector 1 of the present embodiment can hold and accommodate the wiring member W at a more appropriate position.

Further, the partition wall 17 of the protector 1 described above has the first part 17a and the second part 17b bent with respect to the first part 17a. According to such a configuration, in the partition wall 17, since the second part 17b is formed in a curved shape, so that rigidity can be enhanced as compared with a case where the partition wall is formed linearly. Therefore, the protector 1 can ensure more sufficient strength that can withstand a large load applied to the partition wall 17. Therefore, the protector 1 of the present embodiment can hold and accommodate the wiring member W inserted into the first accommodation space portion 10Sa at a more appropriate position.

Note that the protector 1 according to the embodiment of the present invention described above is not limited to the embodiment described above, and various modifications can be made within the scope described in the claims.

For example, the positional relationship between the protector 1 and the part to be fixed A to which the protector 1 is fixed is not limited to the form illustrated in FIG. 3. In the above description, it has been described that the part to be fixed A extends along the length direction X and the height direction Z (that is, the vertical direction), but the part to be fixed A may extend, for example, along the length direction X and the depth direction Y (that is, the horizontal direction). In addition, the part to be fixed A may be disposed facing the side wall portion 12 or may be disposed facing the side wall portion 13. The planar direction of the part to be fixed A is not particularly limited as long as the bottom wall portion 11 constituting the base member 10 extends along the vertical direction, and the pair of side wall portions 12 and 13 and the partition wall 17 extend in the direction intersecting the vertical direction, so that the weight of the wiring member W inserted into the base member 10 is applied to the side wall portion 13 and the partition wall 17 located on the lower side in the vertical direction.

In addition, the number of partition walls 17 is not particularly limited. For example, two partition walls may be provided between the side wall portion 12 positioned on the upper side in the vertical direction and the side wall portion 13 positioned on the lower side in the vertical direction. In this case, the accommodation space portion 10S of the base member 10 may be partitioned by two partition walls into three of a first accommodation space portion positioned on the upper side in the vertical direction, a second accommodation space portion positioned on the lower side in the vertical direction, and a third accommodation space portion positioned in the middle in the vertical direction and formed between the first accommodation space portion and the second accommodation space portion.

In addition, the number of the wiring members accommodated in each of the accommodation space portions vertically divided by the partition wall 17 is not particularly limited.

Further, the shape of the base member 10 is not limited to the form illustrated in FIGS. 1 to 3.

Furthermore, the shape of the partition wall 17 is not limited to the form illustrated in FIGS. 1 to 3. For example, although it has been described that the partition wall 17 is formed in a J shape when viewed from the depth direction Y, the partition wall may be formed in a linear shape or may be formed in another shape such as a U shape.

Although it has been described that the partition wall 17 extends along the extending direction L1 of the protector 1 (alternatively, the extending direction of the pair of side wall portions 12 and 13), the extending direction of the partition wall 17 is not particularly limited as long as it partitions the accommodation space portion 10S into two spaces with respect to the height direction Z.

In addition, the protector 1 according to the present embodiment may be configured by appropriately combining the components of the embodiment described above.

The protector according to the present embodiment can hold and accommodate the wiring member at an appropriate position.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a bottom wall portion extending along a vertical direction in a state of being fixed to a part to be fixed;
a pair of side wall portions provided on both sides with the bottom wall portion interposed therebetween with respect to the vertical direction and formed so as to protrude along a protruding direction intersecting the vertical direction;
an accommodation space portion defined and formed by the bottom wall portion and the pair of side wall portions, into which a plurality of wiring members having conductivity is inserted; and
a partition wall that is formed so as to protrude from the bottom wall portion along the protruding direction and partitions the accommodation space portion into a first accommodation space portion positioned on an upper side in the vertical direction, through which a part of the plurality of wiring members is inserted, and a second accommodation space portion positioned on a lower side in the vertical direction, through which at least a remaining part of the plurality of wiring members is inserted, wherein
the partition wall has a root portion protruding from the bottom wall portion and formed in a curved shape.

2. The protector according to claim 1, wherein
the partition wall is inserted into the first accommodation space portion and comes into contact with the plurality of wiring members arranged side by side along the protruding direction to place the wiring members, and
the side wall portion positioned on the lower side in the vertical direction of the pair of side wall portions is inserted into the second accommodation space portion and comes into contact with the plurality of wiring members arranged side by side along the protruding direction to place the wiring members.

3. The protector according to claim 1, wherein
the partition wall has a first part and a second part bent with respect to the first part.

4. The protector according to claim 2, wherein
the partition wall has a first part and a second part bent with respect to the first part.
